(19) United States
(12) Patent Application Publication
(10) Pub. No.: US 2024/0170985 A1
(43) Pub. Date: May 23, 2024

(54) Charging Device for at Least One Battery Pack

(71) Applicant: Robert Bosch GmbH, Stuttgart (DE)

(72) Inventors: Axel Hubertz, Filderstadt (DE); Jan Koegel, Zusmarshausen (DE)

(21) Appl. No.: 18/502,479

(22) Filed: Nov. 6, 2023

(30) Foreign Application Priority Data
Nov. 18, 2022 (DE) 10 2022 212 288.7

(51) Int. Cl. H02J 7/00

(52) U.S. Cl. CPC H02J 7/0045

(57) ABSTRACT

A charging device having a housing and at least one receiving shaft associated with the housing for receiving a battery pack is disclosed. The at least one receiving shaft includes a battery interface for electrically contacting a battery pack received in the at least one receiving shaft. At least one fan for controlling the temperature of a battery pack received in the at least one receiving shaft is arranged on a side wall of the at least one receiving shaft.

This application claims priority under 35 U.S.C. § 119 to patent application no. DE 10 2022 212 288.7, filed on Nov. 18, 2022 in Germany, the disclosure of which is incorporated herein by reference in its entirety.

### BACKGROUND

The present disclosure relates to a charging device having a housing and at least one receiving shaft, associated with the housing, for receiving a battery pack, wherein the at least one receiving shaft comprises a battery interface for electrically contacting a battery pack received in the at least one receiving shaft.

Such a charging device for charging a battery pack is known from the prior art. The charging device is formed with a housing and a receiving shaft associated with the housing for receiving a battery pack. The receiving shaft comprises a battery interface for electrically contacting a battery pack received in the receiving shaft.

### SUMMARY

The disclosure relates to a charging device having a housing and at least one receiving shaft associated with the housing for receiving a battery pack, wherein the at least one receiving shaft comprises a battery interface for electrically contacting a battery pack received in the at least one receiving shaft. At least one fan for controlling the temperature of a battery pack received in the at least one receiving shaft is arranged on a side wall of the at least one receiving shaft.

The disclosure thus enables a charging device to be provided in which an active temperature control of the charging device and/or a battery pack received in the at least one receiving shaft can be achieved by the at least one fan. Thus, improved temperature control and shortened charging times can be made possible.

Preferably, at least one fan for controlling the temperature of a battery pack received in the at least one receiving shaft is arranged on a side wall of the at least one receiving shaft.

Thus various airflows for controlling the temperature of a battery pack arranged in the at least one receiving shaft can be generated easily and straightforwardly.

Preferably, the at least one or at least two fans are oriented in the longitudinal direction of the housing, wherein the longitudinal direction of the housing is transverse, in particular perpendicular, to a longitudinal direction of a battery pack received in the at least one receiving shaft.

Thus a simple and reliable low around the battery pack for purposes of temperature control can be made possible.

According to one embodiment, at least one receiving bowl is arranged in the housing, the bowl forming the at least one receiving shaft.

Thus a suitable receiving shaft can be formed in a simple way.

Preferably, at least one side wall extension is associated with the at least one receiving shaft, the extension being formed to at least partially enclose a battery pack received in the at least one receiving shaft.

Thus a safe and reliable way to control the temperature of the battery pack can be made possible by providing flow around it.

Preferably, the charging device comprises at least one air diverting hood, which is associated with the at least one receiving shaft and is formed to partially close the at least one receiving shaft.

Thus an indirect control temperature control can be made possible in a simple and straightforward way by diverting an air flow or a swirling flow.

The at least one air diverting hood is preferably arranged on a top side of the housing and/or on a side wall extension of the at least one receiving shaft.

Thus, a suitable arrangement of the at least one air diverting hood can be made possible in a simple way.

According to one embodiment, the at least one air diverting hood comprises air guiding ribs.

Thus an air flow can be securely and reliably directed toward the battery pack.

Preferably, a bottom surface, at least one side wall and/or at least one side wall extension of the receiving shaft comprises air guiding ribs.

This makes it possible to direct further airflows specifically toward the battery pack, whereby a corresponding temperature control can be further improved.

Preferably, an electronic unit is provided, which is arranged between a bottom surface of the at least one receiving shaft and a bottom surface of the housing.

This makes a compact arrangement of the electronic unit possible.

According to one embodiment, the at least one fan is arranged along a vertical axis of the housing between a top side of the housing and components associated with the electronic unit.

Thus a suitable arrangement of the at least one fan can be made possible in a simple way.

According to one embodiment, at least two receiving shafts adjacent to one another are provided along a longitudinal direction of the housing, wherein an electronic unit is arranged between said two receiving shafts adjacent to one another along the longitudinal direction of the housing.

A housing having a comparatively low height can be easily and straightforwardly provided this way.

At least one fan is associated with the electronic unit, wherein the at least one fan associated with the electronic unit can be controlled independent of the at least two fans associated with the receiving shafts.

Thus a temperature control of the at least one battery pack and the electronic unit can take place independent of one another in a simple way.

Preferably, the at least one receiving shaft is formed in such a way that 30% to 50% of a volume of a battery pack received in the receiving shaft can be arranged inside the receiving shaft.

Thus a safe and reliable temperature control of the at least one received battery pack can be made possible by enveloping it with airflows.

### BRIEF DESCRIPTION OF THE DRAWINGS

The disclosure is explained in further detail in the following description with reference to embodiment examples shown in the drawings. Shown are:

FIG. 1 a perspective view of a charging device according to the disclosure, the device having two receiving shafts, wherein a battery pack is arranged in each receiving shaft,

FIG. 2 a perspective view of the charging device of FIG. 1,

FIG. 3 an exploded perspective view of the charging device of FIG. 1 and FIG. 2,

FIG. 4 a sectional view of a receiving shaft of the charging device of FIG. 1 to FIG. 3, with a battery pack,

FIG. 5 a perspective view of the receiving shaft of the charging device of FIGS. 1 to 4, with a battery pack and viewed from an end face,

FIG. 6 a perspective cross-sectional view through an alternative charging device,

FIG. 7 a side view of the alternative charging device of FIG. 6, and

FIG. 8 a perspective view of the alternative charging device of FIG. 6 and FIG. 7.

### DETAILED DESCRIPTION

Elements having the same or a comparable function are provided with the same reference numbers in the figures and are described in detail only once.

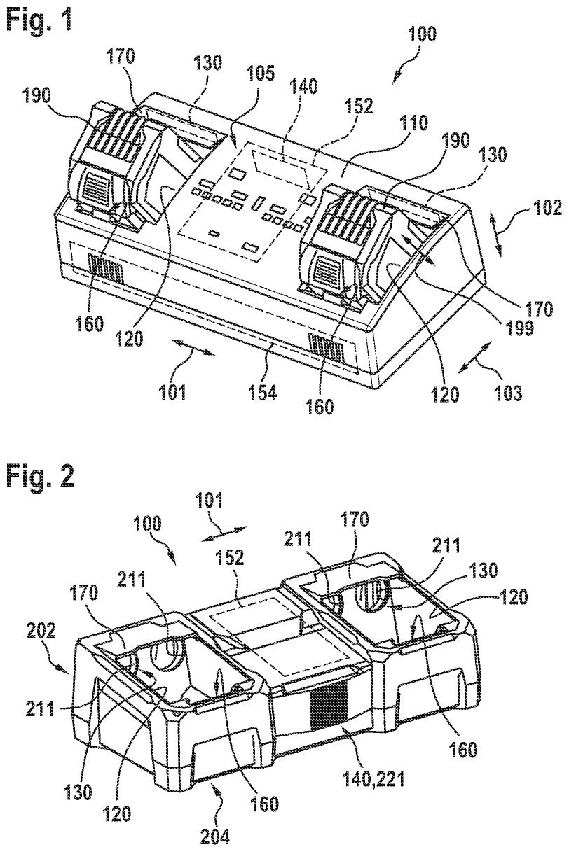

FIG. 1 shows an exemplary charging device 100 having a housing 110 and at least one receiving shaft 120 associated with the housing 110 for receiving a battery pack 190. The charging device 100 is formed to enable charging of a battery pack 190 received in the receiving shaft 120. For this purpose, the at least one receiving shaft 120 comprises a battery interface 160 for electrically contacting the battery pack 190 received in the at least one receiving shaft 120. As an example, the housing 110 is at least approximately cuboid and has a longitudinal direction 101, a vertical axis 102, and a transverse direction 103.

By way of illustration, the charging device 100 comprises two receiving shafts 120 located adjacent to one another along the longitudinal direction 101. For example, a battery pack 190 is received in each of the two receiving shafts 120, respectively. Preferably, an electronic unit 152 is arranged between the two receiving shafts 120 along the longitudinal direction 101. The electronic unit 152 is preferably formed as a low-voltage unit and comprises, for example, an HMI interface, or user interface, and/or a USB interface.

Preferably, each battery pack 190 can be placed in one of the receiving shafts 120 from a top side 105 of the housing 110. According to one embodiment, each receiving shaft 120 is formed in such a way that 30% to 50% of a volume of a battery pack 190 received in the receiving shaft 120 can be arranged inside the receiving shaft 120.

Preferably, an electronic unit 154 is associated with the charging device 100, in particular with each receiving shaft 120 having the battery interface 160. Preferably, the electronic unit 154 is arranged along the vertical axis 102 of the housing 110 below the receiving shaft 120. The electronic unit 154 preferably comprises power electronics and/or a controller.

According to the disclosure, a fan unit 130 having at least one fan (211 in FIG. 2) for controlling the temperature of, preferably cooling, a battery pack 190 received in the receiving shaft 120 is associated with each receiving shaft 120. As a result, airflows can flow around an integral part of the surface of the battery pack 190 received in the charging device 100 or the receiving shaft 120. Preferably, the flow covers more than 70% of the surface of the battery pack 190. Preferably, the at least one fan (211 in FIG. 2) is arranged along the vertical axis 102 of the housing 110 between the top side 105 of the housing 110 and the electronic unit 154. Preferably, the fan unit 130 in FIG. 1 is arranged in the region of an air diverting hood 170. By way of illustration, the air diverting hood 170 is arranged in the transverse direction 103 opposite the battery interface 160. Preferably, a separate fan unit 140 having at least one fan (221 in FIG. 2) is associated with the electronic unit 152.

Preferably, at least one partially formed air diverting hood 170 is associated with at least one receiving shaft 120. Preferably, the at least one air diverting hood 170 is formed to partially close the at least one receiving shaft 120 such that, in order to better control the temperature of a battery pack 190 received in the receiving shaft 120, airflows generated by the fan unit 130 can be diverted by the air diverting hood 170 and can modify the temperature of the battery pack 190 multiple times. It should be noted that in the context of the disclosure, temperature control can be understood to mean cooling by cooling airflows and/or heating by means of warm airflows. An example of the disclosure is described below with the aid of a charging device 100 having at least one fan for cooling.

According to one embodiment, the fan unit 130 comprises at least two fans (211 in FIG. 2). Preferably, the fans (211 in FIG. 2) are oriented or arranged in the longitudinal direction 101 of the housing 110. Hereby, preferably the longitudinal direction 101 of the housing 110 is transverse, in particular perpendicular, to a longitudinal direction 199 of a battery pack 190 received in the at least one receiving shaft 120.

FIG. 2 shows the charging device 100 of FIG. 1, but without the battery packs 190 of FIG. 1. Here, FIG. 2 clearly shows the fan units 130 associated with the two receiving shafts 120. Preferably, each fan unit 130 comprises two fans 211 arranged adjacent to each other in the longitudinal direction 101 of the housing 110.

According to one embodiment, at least one separate fan 221 for controlling temperature, preferably for cooling, is associated with the electronic unit 152. Preferably, the at least one fan 221 associated with the electronic unit 152 can be controlled independent of the fans 211 associated with the receiving shafts 120. Preferably, all fans 211, 221 have a respective diameter of at least approximately 40 mm. It is noted, however, that the fans 211, 221 can also be of any other arbitrary diameter.

According to one embodiment, the fans 211, 221 are at least substantially identically formed, i.e. within the scope of corresponding manufacturing tolerances. However, the fans 211, 221 can also be formed differently, for example they can have different diameters. By way of illustration, the two receiving shafts 120 are arranged in parallel and oriented in a same direction. Alternatively, the two receiving shafts 120 can also be arranged rotated by 180° relative to one another. Furthermore, for illustration purposes the fans 211 are arranged on a rear side 202 of the charging device 100 and the fan 221 is arranged on an opposite front side 204 of the charging device 100. Alternatively, the electronic unit 152 can also be arranged rotated 180° relative to the receiving shafts 120, so that the fan 221 can be arranged on the rear side 202.

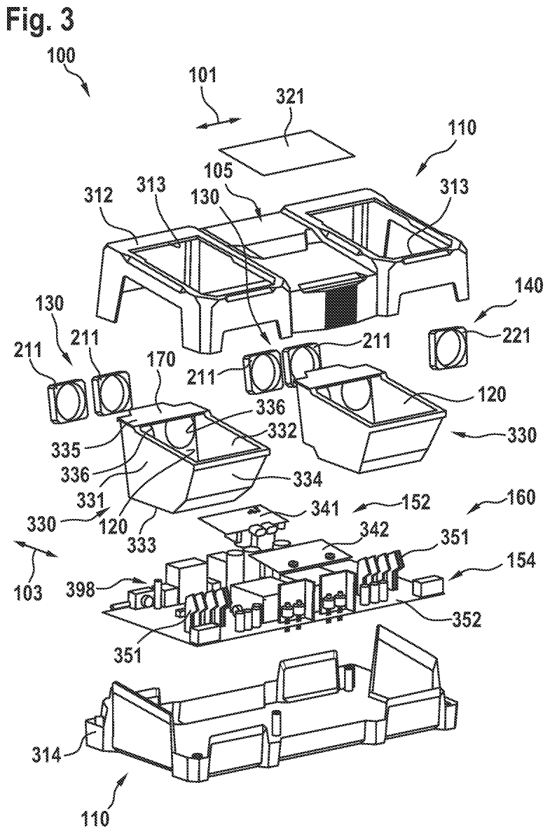

FIG. 3 shows the charging device 100 of FIG. 1 and FIG. 2 with the housing 110. According to one embodiment, the housing 110 comprises, as illustrated, an upper and lower half shell 312, 314. Preferably, at least one and, as illustrated, two receiving shells 330 are arranged in the housing 110, the shells forming the receiving shafts 120. For this purpose, preferably the half-shell 312 comprises recesses 313 associated with the receiving bowls 330.

Preferably, the two receiving bowls 330 as illustrated are formed at least substantially identically formed, i.e. within the scope of corresponding manufacturing tolerances. Preferably, the receiving bowl 330 comprises a trough-shaped base body having a bottom surface 333 and side walls 331, 332, 334, 335. Hereby, as illustrated, the side walls 331 and 332 are aligned along the transverse direction 103 of the housing 110 and the side walls 334 and 335 are aligned along the longitudinal direction 101 of the housing 110. Preferably, the sidewalls 334, 335 are arranged at a predefined angle relative to the bottom surface 333.

Furthermore, the sidewall 334 is preferably associated with the battery interface 160. Preferably, the fan unit 130 or the at least one and the, as illustrated, two fans 211 are associated with the sidewall 335. Preferably, at least two fans 211 for providing temperature control are arranged on the sidewall 335, preferably for cooling a battery pack 190 received in the at least one receiving shaft 120. For this purpose, the side wall 335 comprises receptacles 336 for receiving the fans 211. Moreover, by way of illustration, the air diverting hood 170 is arranged above the receptacles 336 between the side walls 331 and 332. Preferably, the air diverting hood 170 connects the two side walls 331, 332 and thus partially closes the receiving shaft 120.

FIG. 3 also clearly shows the electronic units 152, 154. Here, FIG. 3 shows the electronic unit 154 having a main circuit board 352 that can be arranged in the half-shell 314. The battery interface 160, which has contacting elements 351, is preferably allocated to the electronic unit 154, or to the main circuit board 352. Preferably, in the assembled state of the charging device 100 the contacting elements 351 protrude through slots associated with the receiving shafts 120 in order to make contact with a battery pack 190. Moreover, the electronic unit 154 or the main circuit board 352 comprises power electronic and/or controller components 398. Preferably, a controller for the fans 211, 221 is arranged on the main circuit board 352. Hereby the fans 211, 221 are electrically-conductively connected to the main circuit board 352.

Preferably, at least one and, as illustrated, two printed circuit boards 341, 342 for constructing an HMI interface or a user interface and/or a USB interface are associated with the electronic unit 152. Preferably, a cover 321 is arranged on the top side 105 of the housing 110, or the half-shell 312, is associated with the user interface. For example, the cover 321 protects switches arranged beneath it that can be activated by a user of the charging device 100.

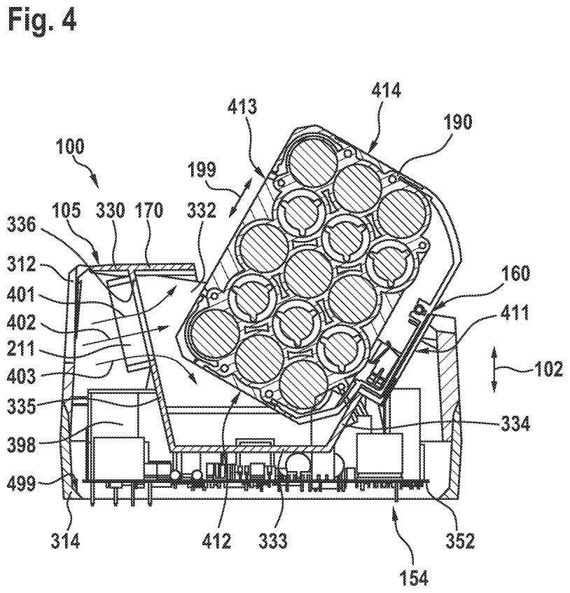

FIG. 4 shows the charging device 100 of FIG. 1 through FIG. 3 with a battery pack 190 arranged in the receiving shaft 120. FIG. 4 illustrates four side surfaces 411, 412, 413, 414 of the battery pack 190. Here, the side surface 411 is formed to be in contact with the battery interface 160 and lies against the side wall 334 of the receiving shaft 120. The side surface 412 of the battery pack 190 is preferably arranged facing the bottom surface 333 of the receiving shaft 120. In addition, the side surface 413 is arranged opposite to the side surface 411, wherein the side surface 413 is arranged partially outside the receiving shaft 120. The side surface 414 is arranged opposite to the side surface 412, wherein the side surface 414 is arranged completely outside the receiving shaft 120. Preferably, the sidewalls 334, 335 of the receiving shaft 120, or the receiving bowls 330, are arranged obliquely relative to the bottom surface 333. Hereby an angle included between the side walls 334, 335 and the bottom surface 333 is preferably greater than 90°. Thus airflows, preferably cooling airflows, can be generated which are directed to the battery pack 190, in particular to the side walls 412, 413.

FIG. 4 also shows the arrangement of the at least one fan 211. The at least one fan 211 is preferably arranged along the vertical axis 102 of the housing 110 between the top side 105 of the housing 110 and components 398 associated with the electronic unit 154. The electronic unit 154 is preferably arranged between the bottom surface 333 of the receiving shaft 120 and a bottom surface 499 of the housing 110.

Furthermore, by way of example, FIG. 4 shows cooling airflows 401, 402, 403 associated with the fan 211. During operation of the fan 211, an exemplary cooling airflow 403 controls the temperature, preferably cooling the side surface 412 of the battery pack 190, and an exemplary cooling airflow 402 cools the side surface 413 of the battery pack 190. An exemplary cooling airflow 401 is preferably diverted at the air diverting hood 170.

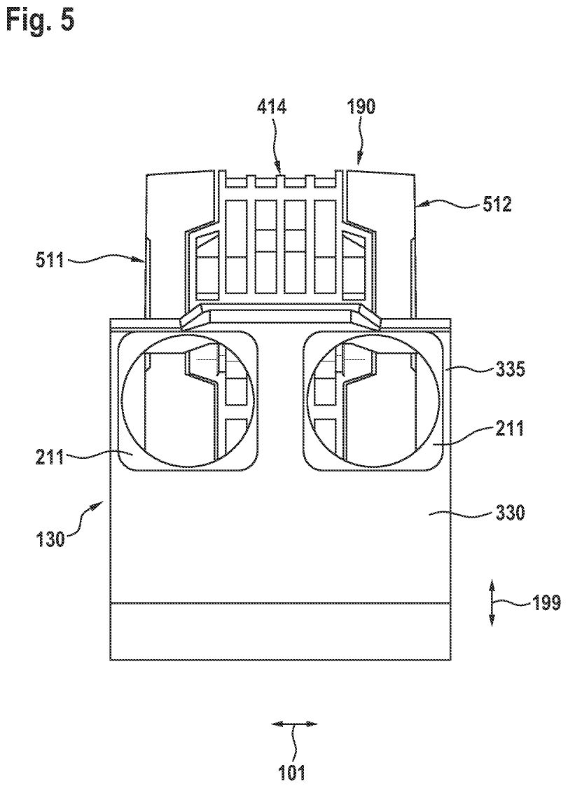

FIG. 5 shows the receiving shaft 120 of the charging device 100 of FIG. 1 to FIG. 4, with a battery pack 190 received therein. FIG. 5 clearly shows, by way of illustration, the adjacent arrangement of the two fans 211 along the longitudinal direction 101 of the housing 110. Hereby the two fans 211 are arranged such that cooling airflows associated with the fans 211 flow around the side surfaces 511, 512 associated with the battery pack 190, the side surfaces being arranged along the longitudinal direction 199 of the battery pack 190. Furthermore, FIG. 5 shows the arrangement of the two fans 211 transverse to the longitudinal direction 199 of the battery pack 190.

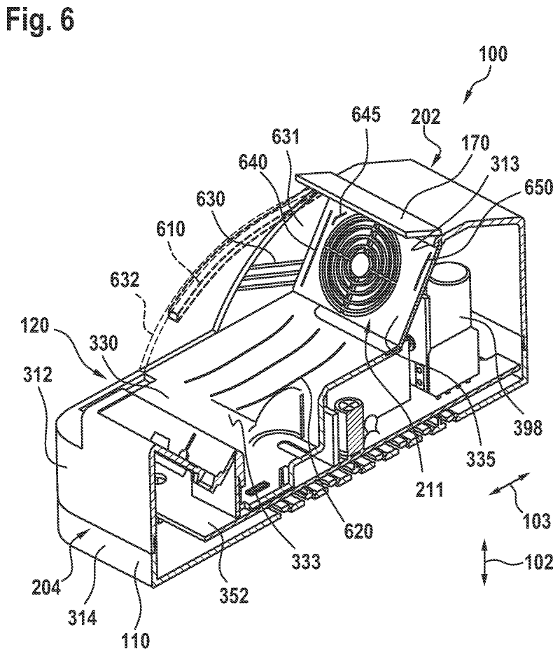

FIG. 6 shows the charging device 100 of FIG. 1 through FIG. 5 according to an alternative embodiment in which at least one sidewall extension 631, 632 is allocated to the receiving shaft 120. The at least one side wall extension 631, 632 is preferably formed to at least partially enclose a battery pack 190 received in the at least one receiving shaft 120. Preferably, the at least one sidewall extension 631, 632 extends the receiving shaft 120 along the vertical axis 102. The at least one sidewall extension 631, 632 is formed along the transverse direction 103 of the housing 110 starting from a region associated with the rear side 202 of the recess 313 and leading to the front side 204. By way of illustration, the sidewall extension 631 is shorter than the sidewall extension 632 along the transverse direction 103.

According to one embodiment, the sidewall extension 632 comprises, at its free end, a diverting hood 610, at least partially. Moreover, at least one air guiding rib 620, 630, 640, 645 is allocated to the receiving shaft 120. Hereby, preferably the bottom surface 333, at least one side wall 331, 332, 334, 335 and/or at least one side wall extension 631, 632 of the receiving shaft 120 comprises at least one air guiding rib 620, 630, 640, 645.

By way of illustration, air guiding ribs 620 are associated with the bottom surface 333, air guiding ribs 630 are associated with the sidewall extension 631, and air guiding ribs 640, 645 are associated with the sidewall 335. Hereby preferably the air guiding ribs 640 are arranged along an entire height of the side surface 335 or lateral to the fan 211, and the air guiding ribs 645 are arranged on the side wall 335 partially radially around the fan 211. Alternatively, or optionally, at least one air diverting hood 170, 610 comprises air guiding ribs 650.

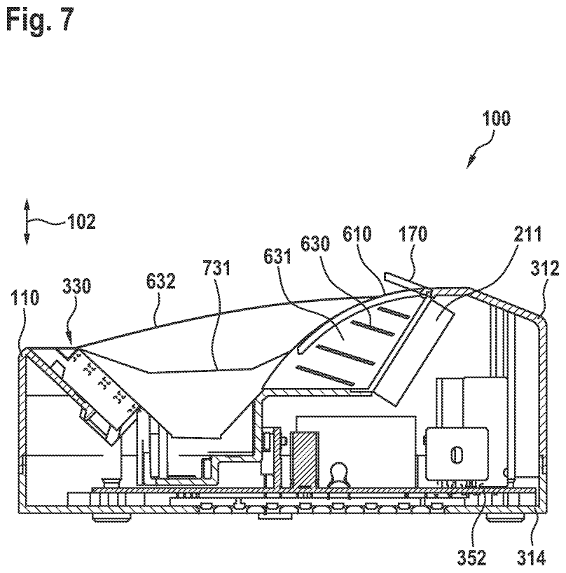

FIG. 7 shows the charging device 100 of FIG. 6 with the side wall extensions 631, 632, the air diverting hoods 170, 610 and air guiding ribs 630. By way of illustration, in FIG. 7 the air diverting hood 610 is associated with the sidewall extension 631. Furthermore, FIG. 7 shows an alternative sidewall extension 731. The sidewall extension 731 has a lower height along the vertical axis 102 than the sidewall extension 632. It is noted that the receiving shaft 120 can comprise the sidewall extension 631, 632, and/or 731. Furthermore, the receiving shaft 120 can also comprise multiple side wall extensions 631, 632, 731, for example the side wall extension 731 together with the side wall extension 631 or 632.

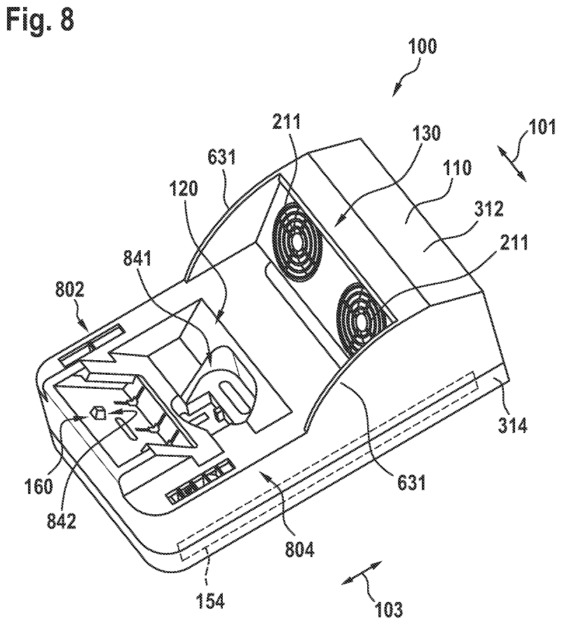

FIG. 8 shows the charging device 100 of FIG. 6 and FIG. 7, with only a single receiving shaft 120 compared to the charging device 100 of FIG. 1 to FIG. 5. The receiving shaft 120 comprises the battery interface 160, which, according to another embodiment, comprises two contacting sections 841, 842. Hereby preferably the contacting section 841 is formed for contacting a plug-in battery pack and the contacting section 842 is formed for contacting a sliding battery pack. Moreover, as illustrated, the housing 110 in each case comprises a side wall extension 631 at its left and right sides 802, 804.

It is noted that the receiving shaft 120, in particular a transition between the bottom surface 333 and at least one side surface 331, 332 and/or a transition between the side surface 335 and at least one side surface 331, 332, can be rounded. In the process, the transitions can comprise air guiding ribs.

It is also noted that the at least one and in particular the two fans 211 of a receiving shaft 120 can control the temperature of a battery pack 190 comparatively quickly and in a controlled way, preferably cooling down the battery pack, such that a user can quickly reuse the same battery pack 190 or can use the same battery pack 190 for longer periods of time during the day, thus allowing efficient use of the battery pack 190. In addition, comparatively rapid temperature control or cooling of a hot battery pack 190 can be made possible.

As described above, the charging device 100 can also heat the battery pack 190, i.e. when a temperature of the battery pack 190 is below a charging temperature, therefore when an ambient temperature is higher than a temperature of the battery pack 190, the battery pack 190 in the receiving shaft 120 can be quickly heated or temperature-controlled back to a charging temperature. For example, the electronic unit 154 can constitute a temperature management system that controls a use of airflows to cool and/or warm up the battery pack 190. Hereby, active temperature control, preferably warming up of the battery pack 190 and/or the charging device 100, can occur before, during, and/or after a charging operation. If the ambient temperature is less than a temperature of the battery pack 190, the battery pack can be further cooled right after a charging operation. Consequently, if the battery pack 190 is reused right away, it is possible to extend the time duration of use of the battery pack 190 when it is used in an electric power tool. Cooling and/or heating of the battery pack 190 preferably preserves the battery pack 190 since the battery pack 190 moves in a critical temperature range for a shorter period of time, thereby achieving a long life of the battery pack. By way of the measures described above, a reduction of a cooling time by more than 25% can preferably be achieved, and a charging time can preferably be reduced by approximately 30%.

What is claimed is:

1. A charging device, comprising:
a housing;
at least one receiving shaft associated with the housing and configured to receive a battery pack, the at least one receiving shaft including a battery interface configured to electrically contact the battery pack received in the at least one receiving shaft; and
at least one fan arranged on a side wall of the at least one receiving shaft,
wherein the at least one fan is configured to control the temperature of the battery pack received in the at least one receiving shaft.

2. A charging device according to claim 1, wherein:
the at least one fan arranged on a side wall of the at least one receiving shaft includes at least two fans each being arranged on the side wall of the at least one receiving shaft, and
the at least two fans are configured to control the temperature of the battery pack received in the at least one receiving shaft.

3. The charging device according to claim 1, wherein:
at least one of the at least two fans is oriented in a longitudinal direction of the housing, and
the longitudinal direction of the housing extends transversely to a longitudinal direction of the battery pack received in the at least one receiving shaft.

4. The charging device according to claim 1, further comprising at least one receiving bowl arranged in the housing, the receiving bowl forming the at least one receiving shaft.

5. The charging device according to claim 1, wherein at least one side wall extension is associated with the at least one receiving shaft, the at least one side wall extension being formed to at least partially enclose the battery pack received in the at least one receiving shaft.

6. The charging device according to claim 1, further comprising at least one air diverting hood which is associated with the at least one receiving shaft and formed to partially close the at least one receiving shaft.

7. The charging device according to claim 6, wherein the at least one air diverting hood is arranged on a top side of the housing.

8. The charging device according to claim 7, wherein the at least one air diverting hood comprises air guiding ribs.

9. The charging device according to claim 1, wherein a bottom surface, at least one side wall and/or at least one side wall extension of the receiving shaft comprises air guiding ribs.

10. A charging device according to claim 1, further comprising an electronic unit which is arranged between a bottom surface of the at least one receiving shaft and a bottom surface of the housing.

11. The charging device according to claim 10, wherein the at least one fan is arranged along a vertical axis of the housing between a top side of the housing and components associated with the electronic unit.

12. The charging device according to claim 1, further comprising:
at least two receiving shafts located adjacent to one another along a longitudinal direction of the housing; and
an electronic unit arranged between the at least two receiving shafts.

13. The charging device according to claim 11, further comprising at least one fan associated with the electronic unit,
wherein said at least one fan associated with the electronic unit is configured to be controlled independent of the fans associated with the at least two receiving shafts.

14. The charging device according to claim 1, wherein the at least one receiving shaft is formed in such a way that 30% to 50% of a volume of the battery pack received in the at least one receiving shaft is arranged inside the at least one receiving shaft.

15. The charging device according to claim 1, wherein:
at least one of the at least two fans is oriented in a longitudinal direction of the housing, and
the longitudinal direction of the housing extends perpendicular to a longitudinal direction of the battery pack received in the at least one receiving shaft.

16. The charging device according to claim 6, wherein the at least one air diverting hood is arranged on the at least one side wall extension of the at least one receiving shaft.

17. The charging device according to claim 16, wherein the at least one air diverting hood comprises air guiding ribs.
